(19) United States
(12) Patent Application Publication
(10) Pub. No.: US 2006/0104517 A1
(43) Pub. Date: May 18, 2006

(54) Template-based face detection method

(76) Inventors: Byoung-Chul Ko, Seoul (KR); Jong-Chang Lee, Suwon-si (KR); Hyun-Sik Shim, Yongin-si (KR)

Correspondence Address: Robert E. Bushnell, Suite 300, 1522 K Street, N.W., Washington, DC, 20005-1202, US

(21) Appl. No.: 11/262,842

(22) Filed: Nov. 1, 2005

(30) Foreign Application Priority Data
Nov. 17, 2004 (KR) 2004-94368

(51) Int. Cl. G06K 9/62; G06K 9/36

(52) U.S. Cl. 382/209; 382/276

(57) ABSTRACT

A template-based face detection method includes: producing an average face image from a face database, wavelet-converting the produced face image, and removing a low frequency component of high and low frequency components of the converted image, the low frequency component being sensitive to illumination; producing a face template with only high horizontal and vertical frequency components of the high frequency components; and retrieving an initial face position using the face template when an image is inputted, and detecting the face in a next frame by using, as a face template for the next frame, a template obtained by linearly combining the face template with a high frequency wavelet coefficient corresponding to the position of the face in a current frame. Thus, the method has a shortened calculation time for face detection, and can accurately detect a face irrespective of skin color and illumination.

### CLAIM OF PRIORITY

This application makes reference to, incorporates the same herein, and claims all benefits accruing under 35 U.S.C. §119 from an application for TEMPLATE-BASED FACE DETECTION METHOD earlier filed in the Korean Intellectual Property Office on Nov. 17, 2004 and there duly assigned Serial No. 2004-94368.

### BACKGROUND OF THE INVENTION

1. Technical Field

The present invention relates to a method for detecting a face area in real time, and more particularly, to a method for detecting a face by producing a face template and changing a coefficient value of the template according to an environment to detect the face irrespective of skin color and illumination such that the inventive method has various possible applications, such as video conference systems, video monitoring systems, and face recognition systems.

2. Related Art

A face detection technique is an essential technique in various application fields, such as face recognition, video monitoring, and video conferencing. Various face detection methods have been studied over the past years.

A first step for face detection is to determine whether there is a face in an image, and if so, to detect an exact position of the face. However, it is difficult to always achieve exact face detection due to a large number of variables, such as the size of the face contained in an image, the angle of the face with respect to a camera, facial expression, partial concealing of the face, illumination, skin color, and facial features.

Typical face detection methods include a knowledge-based method, a feature-based method, a neural network-based method, and a template-based method.

The knowledge-based method uses knowledge regarding facial features, in which a rule between respective elements of the face is pre-defined, and it is determined whether a candidate face area meets this rule so as to determine whether the area is a face. However, such a method is of limited effectiveness because the necessary criteria regarding facial features and the like are difficult to define due to a large number of variables, such as those mentioned above.

The feature-based method utilizes facial feature information, such as colors and boundary lines of a face. One type of feature-based method, a color-based method, is most widely used. Such a method has a short processing time, and thus it can be performed at high-speed, but it is sensitive to change in color components due to illumination, and is unable to differentiate between a background and a face when color components of the background and the face are similar.

In the neural network-based method, various faces and non-faces are defined as learning data, learning is accomplished based on the learning data through a neural network, and then it is determined whether an input candidate face area is an actual face. This type of method is highly accurate and reliable, but it takes a long time in learning and calculating, and therefore it is not suitable for real-time face detection.

Recently, a method with a pattern recognizer, such as a support vector machine (SVM) or an Adaboost, has been widely used. However, the SVM is not suitable for real-time application since retrieval and detection results significantly depend on the number of support vectors and the dimension of a feature vector. The Adaboost has a short detection time compared to the SVM, but detection performance and calculation time depend on the learning stage.

Finally, in the template-based method, several standard face patterns for a face are defined, an input image is matched to any of the defined standard face patterns, and a part of the input image that is most exactly matched to the standard face pattern is determined to be the face.

Korean Laid-open Patent Publication No. 10-2004-42501 (May 20, 2004), entitled “Template-based Face Detection Method Matching” introduces a technique for detecting a face based on a template. In the disclosed technique, an image acquired by a camera serving as an image acquisition means is inputted to a face detecting and tracking system. The input image undergoes pre-processing, such as light correction for detection error reduction, and a face candidate area is obtained with a color, i.e., a skin color. The face candidate area is wavelet-converted, a wavelet template is obtained by using the wavelet-converted face image, and then the wavelet template is compared to or matched with a wavelet face template obtained beforehand from an average face image, thus detecting the face. After the face is detected through the wavelet template matching, elements making up the face (eyes, eyebrows, a mouth, a nose, etc.) are detected, and the elements are mapped onto a facial ellipse prepared beforehand, thus obtaining a final face area. A position of a face in a next image is predicted and tracked with three pieces of previous face position information.

Such a template-based method provides simple calculation and accurate performance, but it is sensitive to variation in the size and angle of the face, illumination, noise, and the like.

### SUMMARY OF THE INVENTION

The present invention provides a template-based method for detecting a face from image information, which method is less sensitive to variation in facial features and expression, illumination, facial concealment, and the like.

According to a preferred embodiment of the method of the present invention, an average face for template matching is produced in a preparation step. Specifically, a learning face image containing various faces of different races is acquired, and the average face for the template matching is produced from the learning face image, and is wavelet-converted to produce a face template of two high horizontal and vertical frequencies. After the face template is prepared, an input image is down-sampled to various sizes and wavelet-converted. Here, the input image is down-sampled in order to detect all faces of various sizes contained in the image. The wavelet-converted input image is matched with the template that is similarly wavelet-converted, and an area having the highest matching score is specified as the face area. After the face area is specified, coefficient values of high horizontal and vertical wavelet frequencies are extracted from the specified face area, and are linearly combined with the template. This allows the face template to be re-adjusted to match different individuals. Then, a next position of a candidate face for face tracking is determined. In this regard, the next position of the candidate face is determined to be a position expanded in size from a center of the detected current face by a width m and a height n.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an overall flowchart of a template-based face detection method according to an embodiment of the present invention;

FIG. 2 is a graph showing experimental results obtained using a template-based face detection method different from the method of the present invention;

FIG. 3 is a graph showing experimental results obtained using a varying weight according to an embodiment of the present invention;

FIG. 4 illustrates an image screen showing reduced sensitivity to variation in skin color and illumination according to an embodiment of the present invention; and

FIG. 5 is a graph showing change in a template coefficient value newly formed in each frame.

### DETAILED DESCRIPTION OF THE PREFERRED EMBODIMENTS

Hereinafter, an exemplary embodiment of the present invention will be described in more detail with reference to the accompanying drawings. It should be noted that, in the drawings, the same or similar components are designated by the same reference numerals or symbols to the extent possible although being represented in the other drawings. Further, in describing the invention, if it is determined that the detailed description of known functions or configurations unnecessarily makes the gist of the invention ambiguous, the detailed description will be omitted.

First, a template-based face detection method according to an embodiment of the present invention will be discussed.

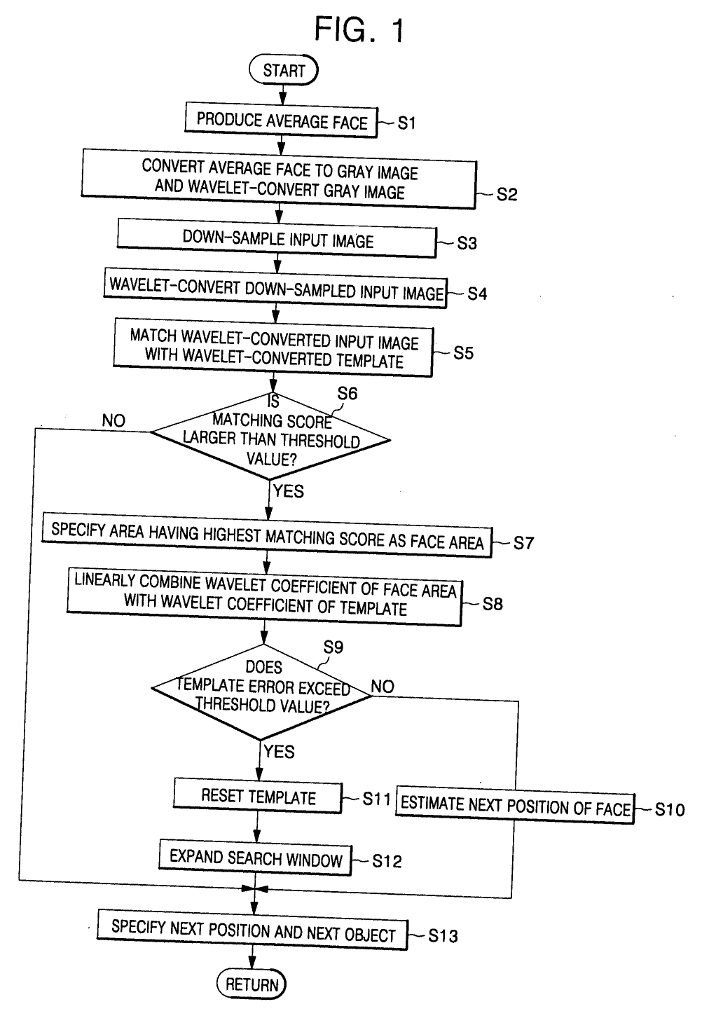

FIG. 1 is an overall flowchart of a template-based face detection method according to an embodiment of the present invention.

Referring to FIG. 1, face images are acquired from a database containing various human races to produce an average face (S1). The average face is converted into a gray image, and the gray image is wavelet-converted (S2). A template having only two horizontal and vertical high frequency components is produced from the result of the wavelet conversion.

When an image is inputted, the input image is down-sampled and reduced to at least one step (S3), and the down-sampled image is wavelet-converted (S4).

The wavelet-converted input image is then matched with the wavelet-converted template (S5). It is then determined whether the matching score is larger than a threshold value (S6), and if so, an area having the highest matching score is specified as a face area (S7).

Coefficient values of high horizontal and vertical wavelet frequencies are then extracted from the detected face area and linearly combined with the template (S8).

A minimum template error between the coefficient value of the fixed template and the coefficient value of the face area in the current frame is measured in every frame, and it is determined whether the template error exceeds a threshold value (S9). If the template error does not exceed the threshold value, a position expanded by a size of width m and height n from a center of the detected current face to track the face is estimated to be a next position of the candidate face (S10).

On the other hand, if the template error exceeds the threshold value, it is concluded that there is a sudden motion, concealing of a face, or a sudden illumination change. Hence, the coefficient value of the face template is reset to a new template value (S11), a search window is expanded (S12), and a next position and a next object are specified to perform subsequent template matching (S13).

Producing the face template using the wavelet conversion will now be discussed in more detail.

In the above-described embodiment of the present invention, the average face image is wavelet-converted to produce the face template.

First, to make the average face, a face area from eyebrows to upper lip is split into the same width and height to produce learning data using a public face database containing white people, oriental people, and black people, available from Surrey University in the UK and Carnegie Mellon University (CMU) in the USA. The split of only the face area from the eyebrows to the upper lip is intended to produce a face template less sensitive to the change in facial expression. The average face is produced by splitting the respective faces, and is normalized to 40×40 in size.

The average face thus produced is then converted into the gray image and wavelet-converted. In the wavelet conversion, the input image is decomposed into high vertical, horizontal, and diagonal frequency components, and a low frequency component, and is down-sampled.

In the present invention, to shorten the matching time, the image is wavelet-converted two times so that the image is down-sampled to ¼ of its original size. The two-step wavelet conversion of the average face down-samples the actual average face to 10×10 in size, which is ¼ of the original size, and it is decomposed into the three high horizontal, vertical, and diagonal frequency components, and one low frequency component. At this time, the high frequency component, typically containing the diagonal component of the four frequency components, is removed because it is not used for the face template.

Furthermore, in the present embodiment of the present invention, since the low frequency component is more sensitive to illumination change than the high frequency components, it is also removed, and only the two horizontal and vertical high frequency components are used, thus shortening matching time and increasing accuracy.

To measure the performance of the method with only the two high frequency templates according to the embodiment of the present invention, a case wherein the low frequency template is used together with the two horizontal and vertical high frequency templates, and a case wherein only the two high frequency templates are used, were tested with an experimental video.

The experimental video was composed of six moving images containing various illumination changes, rapid motion, change in facial expression, and the like.

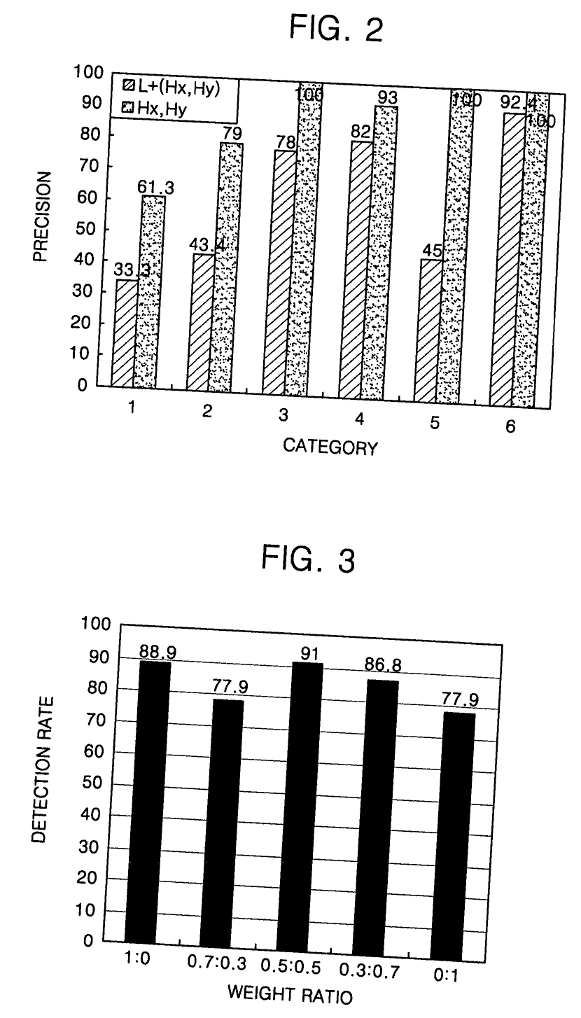

FIG. 2 is a graph showing experimental results obtained using a template-based face detection method different from the template-based face detection method of the present invention.

Referring to FIG. 2, the experimental results show that the average face detection rate was 62% when the three templates L+(Hx,Hy) containing the low frequency component were used, while it was as high as 89% when the two templates (Hx,Hy) containing only the high frequency components were used. This is because the low frequency component contains a relatively high light component, and thus the change in the coefficient value of the template with respect to the illumination change is relatively greater compared to the high frequency components.

Furthermore, even in detecting faces of different races, the use of the low frequency component may degrade the detection rate because there is a relatively large difference in brightness between the skin of a black man and that of a white man. The experiment shows that the use of the low frequency component degrades face detection performance by increasing sensitivity to variation in skin color and illumination, compared to use of only the high frequency components.

The input image down-sampling for the template matching will be now discussed in more detail.

Examples of the exact matching method for various sizes of input faces include methods in which several templates or only one template fit to respective face sizes are pre-defined, and the faces are matched with the templates while down-sampling the input image.

The present embodiment of the present invention uses a method in which only one template is pre-defined and matched with the face while down-sampling the input image so as to reduce the amount of memory required for processing.

More rate steps of the input image down-sampling result in a more accurate matching result, but it is not suitable for real-time processing. Accordingly, in the present embodiment, the input image is down-sampled into 100%, 80%, 60%, and 40% sizes.

In this case, if an image of a QCIF size (176×144), which is a video format of a cellular telephone, is inputted, it is possible to detect faces from 90×90 pixels to a minimum size of 30×30 pixels.

The template matching will be now discussed in more detail.

Template matching is a task in which three down-sampled input images are each wavelet-converted and down-sampled to ¼ in size, and the respective down-sampled input images are subject to one-to-one matching with the two pre-defined high frequency templates while the positions thereof are changed. If the sum of similarities between a specific area of the input image and the two templates is larger than a threshold value, the specific area is determined to be a candidate face area.

The independent matching is carried out for the four respective images (100%, 80%, 60%, and 40%), and an image area having the highest of the four similarity sums is selected as a face area, and is magnified back into the original image so as to calculate an actual size of the face.

The template matching in the first frame occurs with the entire image, while the template matching in subsequent frames occurs within the search window, which is set from a previous face position, thus shortening the detection time.

The size of the search window was set to be 6× larger than the face size when the down sampling rate is 100% (original size), 5× larger when it is 80%, 4× larger when it is 60%, and 2× larger when it is 40%.

The process of deforming the face template will now be discussed in more detail. There are basically three different methods of detecting the face using the face template.

A first method uses a pre-defined fixed template. Use of a fixed face template may provide optimal performance if the faces in an entire video have the same size and shape. However, people's different facial structures, and variations in illumination, angle of the face, etc., degrade the accuracy of the matching method using the fixed template.

The fixed template matching method may be represented by the following Equation 1:
Tₙ₊₁(x,y)=T(x,y) for all n≧1 <Equation 1>
where n is the number of frames, Tₙ₊₁, is a template used in a next frame, and T denotes a pre-defined template.

A second method involves production of a variable face template. Here, rather than using a single fixed template, a face is found in the first frame by using colors, a personalized template is produced using that information, and then the produced personalized template is used as a template for subsequent successive frames. However, even in this method, once the personalized template is produced, it cannot be changed. Accordingly, this method is sensitive to variation in illumination, angle, facial expression, etc., in subsequent frames.

The second method may be simply represented by the following Equation 2:
Tₙ₊₁(x,y)=T₁(x,y) for all n≧1 <Equation 2>
where T₁ denotes the template defined in the first frame.

A third method involves updating a face template every frame. Here, a face area is found in a first frame and set as an initial face template, and a current face area in every frame is used to update a next face template. Using this method, in the absence of any sudden changes in illumination, the face, etc., there is only a small difference between the original face template and the next face template, and thus a relatively good result is obtained. However, the face area template value continuously changes due to illumination change, face motion, expression change, and the like. Further, as the number of the frames increases, the next face template has a different value from the original face template. This may result in local minima, thus missing an exact face.

Furthermore, in the case where the image is set back to the original image in the next frame after the face template value is changed due to rapid change of facial expression, illumination, motion, or the like, it is likely that a very different object will be detected as the face area because the template value has already been changed.

The third matching method may be simply represented by the following Equation 3:
Tₙ₊₁(x,y)=T(Iₙ(x,y)) for all n≧1 <Equation 3>
where T(Iₙ(x,y)) denotes a position of the face found in the n-th frame.

Accordingly, in the present embodiment of the invention, an initial face position is retrieved by using the wavelet-converted fixed face template T, and, in a next frame, the fixed face template is linearly combined with a high frequency wavelet coefficient, T(In(x,y)), corresponding to the position of the face in the current frame, so as to obtain the face template Tn+1 for the next frame, as indicated by the following Equation 4:

$${T}_{n + 1} ( x , y ) = [ {w}_{1} {w}_{2} ] \cdot [ \begin{matrix}T \\ T ( {I}_{n} ( x , y ) )\end{matrix} ] \qquad \text{<} Equation 4 \text{>}$$

Here, a weight should be set between the fixed template and the wavelet coefficient corresponding to the face area in the current frame. To obtain the weight, an experiment with a varying weight was carried out for six experimental videos.

FIG. 3 is a graph showing experimental results obtained using a varying weight according to an embodiment of the present invention.

As shown in FIG. 3, 1:0 corresponds to the case of using the pre-defined fixed template among the face template deformations, and 0:1 corresponds to the case of updating the face template in every frame. In the experiment, a maximum detection rate of 91% was obtained when a weight of 0.5:0.5 was given between the fixed template T and the face area T(In(x,y)) in the new frame. Therefore, in the present embodiment of the invention, the weight between the fixed template and the new template is preferably 0.5:0.5.

However, regardless of the extent to which the fixed template maintains unique features of the face, fast motion, concealing of the face and sudden illumination change may cause the value of the face template to be greatly changed. Thus, a mean absolute error (MAE) between the fixed template T and a newly produced template is measured in every frame to prevent an error in detection, and when the mean absolute error exceeds a reference threshold value, the new face template Tn+1 is reset as the fixed template T in the next frame to search for the face area again in the entire image. This may be represented by the following Equation 5:

$$MSC = {\sum }_{x , y ∈ T} ‖ T ( x , y ) - T ( {I}_{n} ( x , y ) ) ‖ \\ if MSE \geq ɛ then Tn + 1 ( x , y ) = T ( x , y ) \\ else {T}_{n + 1} ( x , y ) = T ( {I}_{n} ( x , y ) ) \qquad \text{<} Equation 5 \text{>}$$

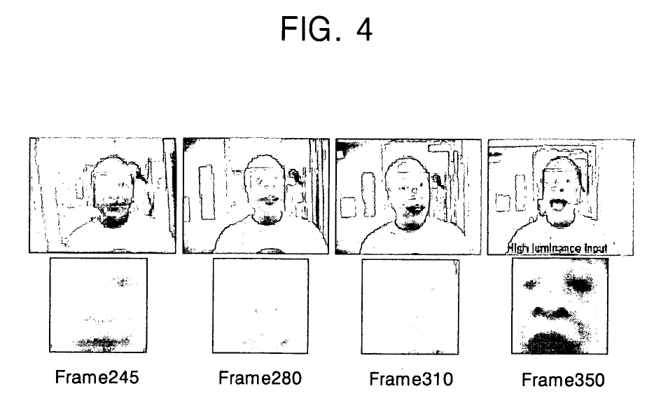

FIG. 4 illustrates an image screen showing reduced sensitivity to variation in skin color and illumination according to an embodiment of the present invention. In particular, FIG. 4 shows the result of detecting a face from successive frames with large changes in illumination and in which a black man is included, and the result of magnifying the detected face area.

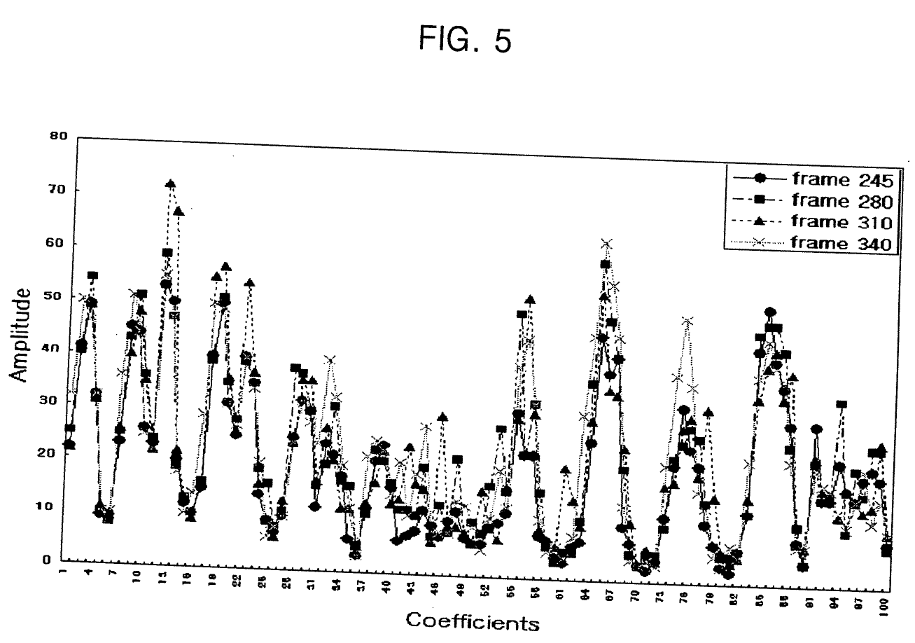

FIG. 5 is a graph showing change in a template coefficient value newly formed in each frame. The graph shows how much the wavelet coefficient value used as the template changed in 245 to 340 frames. From the graph, it can be seen that the value of the wavelet coefficient is not greatly changed from the value of the unique face template, even when there is a significant change in facial expression or illumination.

As can be seen from the foregoing, with the method according to the present invention, it is possible to quite accurately detect a face irrespective of illumination change and other variables.

As described above, in the embodiment of the present invention, to reduce matching time and enhance accuracy, the face template is wavelet-converted, a low frequency component sensitive to illumination is removed from the converted image, and then only horizontal and vertical high frequency components containing key elements of an actual face are used as the template. Further, the template thus defined should vary with face shape and skin color of a person contained in the input image, the illumination, and the like in order to detect the exact face. Accordingly, the template is designed so that the coefficient value varies with image input time. Similarly, the input image undergoes the process of being wavelet-converted and down-sampled, and a pre-defined template is matched with each frequency component of the image. By doing so, it is possible to shorten the calculation time for face detection, and to accurately detect the face irrespective of skin color and illumination.

Therefore, according to the face detection method of the present invention, it is possible to perform face detection which is less sensitive to change in illumination, expression and the like. This face detection method may be applied to, for example, video communication via cellular telephone terminals used by various human races, a visual device for a domestic robot operating in an environment with significant illumination changes, and a telematics-related drowsiness prevention system.

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

What is claimed is:

1. A template-based face detection method, comprising the steps of:
producing a template containing only two horizontal and vertical high frequency components selected from a result of producing and wavelet-converting an average face;
down-sampling an input image by at least one step and wavelet-converting the down-sampled input image; and
matching the wavelet-converted input image to the template to identify an area of the input image having the highest matching score as a face area.

2. The method according to claim 1, further comprising the steps of:
extracting coefficient values of high horizontal and vertical wavelet frequencies from the identified face area and linearly combining the coefficient values with the template; and
determining a next position of a candidate face for face tracking.

3. The method according to claim 2, wherein a threshold value for linearly combining the coefficient values in a current frame with the template is 0.5:0.5.

4. The method according to claim 2, further comprising the step of measuring a minimum average error in every frame between a coefficient value of the template and the coefficient value of the face area in the current frame, and when the average error is larger than a threshold value, concluding that there is at least one of a sudden motion, concealing of the face, and sudden illumination change, and resetting the coefficient value of the face template to a new template value.

5. The method according to claim 2, wherein the next position of the candidate face is determined to be a position expanded in size from a center of the detected current face by a width m and a height n.

6. The method according to claim 1, wherein the step of producing the template comprises:
acquiring learning face images containing images of various human races to produce an average face for template matching; and
wavelet-converting the produced average face to produce the template containing the two horizontal and vertical high frequency components.

7. The method according to claim 6, wherein the step of wavelet-converting the produced average face to produce the template containing the two horizontal and vertical high frequency components comprises:
wavelet-converting the average face and removing a low frequency component from high and low frequency components of the wavelet-converted image, the low frequency component being sensitive to illumination; and
defining only a high horizontal and the vertical frequency components of the high frequency components as the template.

8. The method according to claim 1, wherein wavelet-converting is performed in two steps to reduce a size of an original image by a factor of ¼.

9. The method according to claim 1, wherein the down-sampled input image is down-sampled to rates of 100%, 80%, 60% and 40%.

10. A template-based face detection method, comprising the steps of:
producing an average face image from a face database, wavelet-converting the produced average face image, and removing a low frequency component of high and low frequency components of the wavelet-converted image, the low frequency component being sensitive to illumination;
producing a face template with only high horizontal and vertical frequency components of the high frequency components; and
retrieving an initial face position using the face template when an image is inputted, and detecting a face in a next frame by using, as a face template for the next frame, a template obtained by linearly combining the face template with a high frequency wavelet coefficient corresponding to a position of the face in a current frame.

11. The method according to claim 10, wherein the step of detecting the face comprises:
down-sampling the input image in a stepwise manner;
wavelet-converting the down-sampled input image; and
matching the wavelet-converted input image to each frequency component of the face template to specify a face area.

12. The method according to claim 11, further comprising the steps of:
extracting coefficient values of high horizontal and vertical wavelet frequencies from the specified face area, and linearly combining the coefficient values with the face template; and
determining a next position of a candidate face for face tracking.

13. The method according to claim 12, further comprising the steps of:
measuring a minimum average error in every frame between a coefficient value of the face template and a coefficient value of the face area in the current frame; and
when the minimum average error is larger than a threshold value, concluding that there is at least one of a sudden motion, concealing of the face, and a sudden change in illumination, and resetting the coefficient value of the face template to a new template value.
